(19) United States
(12) Patent Application Publication
(10) Pub. No.: US 2007/0091082 A1
(43) Pub. Date: Apr. 26, 2007

(54) DISPLAY APPARATUS

(75) Inventor: Hung-Chieh Huang, Hsinchu (TW)

Correspondence Address: J C PATENTS, INC., 4 VENTURE, SUITE 250, IRVINE, CA, 92618, US

(73) Assignee: CORETRONIC CORPORATION, Hsinchu (TW)

(21) Appl. No.: 11/532,423

(22) Filed: Sep. 15, 2006

(30) Foreign Application Priority Data
Oct. 20, 2005 (TW) 94136673

(51) Int. Cl. G09G 5/00

(52) U.S. Cl. 345/207

(57) ABSTRACT

A display apparatus is provided. The display apparatus includes a displaying unit and an ambient brightness sensor. A plurality of gamma curves is stored in the displaying unit, and the displaying unit provides an image based on one of the gamma curves. The ambient brightness sensor disposed on and electrically connected with the displaying unit is used for sensing the ambient brightness and selecting the gamma curve accordingly. By using the ambient brightness sensor to select a suitable gamma curve, the display apparatus of the present invention is capable of providing the preferable image based on the selected gamma curve.

### CROSS-REFERENCE TO RELATED APPLICATION

This application claims the priority benefit of Taiwan application serial no. 94136673, filed on Oct. 20, 2005. All disclosure of the Taiwan application is incorporated herein by reference.

### BACKGROUND OF THE INVENTION

1. Field of Invention

The present invention relates to a display apparatus. More particularly, the present invention relates to a display apparatus capable of selecting a gamma curve for displaying images based on the ambient brightness.

2. Description of Related Art

Various types of display apparatuses are available in modern life that a user enjoys watching desired images at home, in the office, in a meeting room or even in a transport vehicle. Accordingly, a display apparatus is provided images with suitable gray scale according to the ambient brightness. Besides, the brightness actually perceived by the human eyes is not linear to a change of ambient light intensity. Thus, in order to eliminate a deviation of the gray scale caused by the ambient brightness of the environment where the user is, a gamma curve is normally used for adjustment or compensation. A gamma curve is a response curve for simulating and approximating the human eyes to light, and it follows the functional relation, y=x^{g}, in which y is the brightness, x is the gray scale value and g is the gamma constant. A different gamma constant g corresponds to a different gamma curve, i.e. a different relation of the brightness y and the gray scale value x. When the gamma constant g is relatively small, the output brightness of the display apparatus is comparatively high in the middle range of the gray scale value. The way of improving images by adjusting gamma curve in a conventional display apparatus is described as follows.

Referring to FIG. 1, it shows the adjustment of a gamma curve in a conventional display apparatus. In FIG. 1, the abscissa is the gray scale value (e.g. 0˜255 corresponding to 256 representations of brightness), the ordinate is the brightness (i.e. the brightness perceived by the human eyes) and the horizontal line K is the ambient brightness line (supposing the value is a constant). Before adjustment, the gamma curve is curve A and its gamma constant g is fixed to 2.2. The curve A is originally able to provide the brightness corresponding to every gray scale value in the range of 0˜255, as shown in FIG. 1. However, the ambient brightness value (horizontal line K) in the range of the gray scale values 0˜X is beyond the brightness provided by curve A. Therefore, the part of the gray scale does not appear clearly because of the interference of the ambient brightness. In order to solve the problem, the conventional display apparatus raises the brightness to prevent the gray scale value 0˜X from the influence of the ambient brightness. The regulative gamma curve is the curve A′. Therefore, the range of the gray scale value 0˜X, which is previously interfered by the ambient brightness, is effectively displayed with the raising of brightness, i.e. the brightness of all the gray scale values is applied. However, the conventional way of adjusting gamma curves leads to a restriction and reduction of the available range of the brightness in the display apparatus. As shown in FIG. 1, the variable range of curve A′ in the brightness axis is reduced obviously.

Thus, in the prior art, the interference of the ambient brightness is improved by raising the brightness to adjust the gamma curves. However, it leads to the insufficiency of available brightness range in the conventional display apparatus. Besides, if there is any change in the ambient brightness, the display apparatus is not able to adjust the gamma curve properly in time to provide a preferable image.

### SUMMARY OF THE INVENTION

Accordingly, the present invention is directed to provide a display apparatus which adjusts the adopted gamma curve in time according to an ambient brightness for providing a preferable image.

The present invention provides the display apparatus, which includes a displaying unit and an ambient brightness sensor. A plurality of gamma curves is stored in the displaying unit, and the displaying unit provides an image based on one of the gamma curves. The ambient brightness sensor disposed on and electrically connected with the displaying unit is used for sensing the ambient brightness and selecting the gamma curve accordingly.

Each gamma curve stored in the above displaying unit corresponds to a gamma constant.

The above displaying unit is a projecting system, a liquid crystal display, a Plasma Display Panel (PDP), a Cathode Ray Tube (CRT), an Organic Electro-Luminescent Display panel (OELD panel), a Lighting Emitting Diode Display panel (LED panel) or a Field Emission Display panel (FED panel).

The said ambient brightness sensor is a Photo Diode (PD).

By using the ambient brightness sensor to detect the ambient brightness, a suitable gamma curve is selected according to the ambient brightness, and the display apparatus of the present invention is capable of providing the preferable image suitable for the current ambient brightness.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows the adjustment of the gamma curves in a conventional display apparatus.

FIG. 2 shows the display apparatus according to the embodiment of the present invention.

FIG. 3 shows a plurality of gamma curves stored in the displaying unit according to an embodiment of the present invention.

### DESCRIPTION OF THE EMBODIMENTS

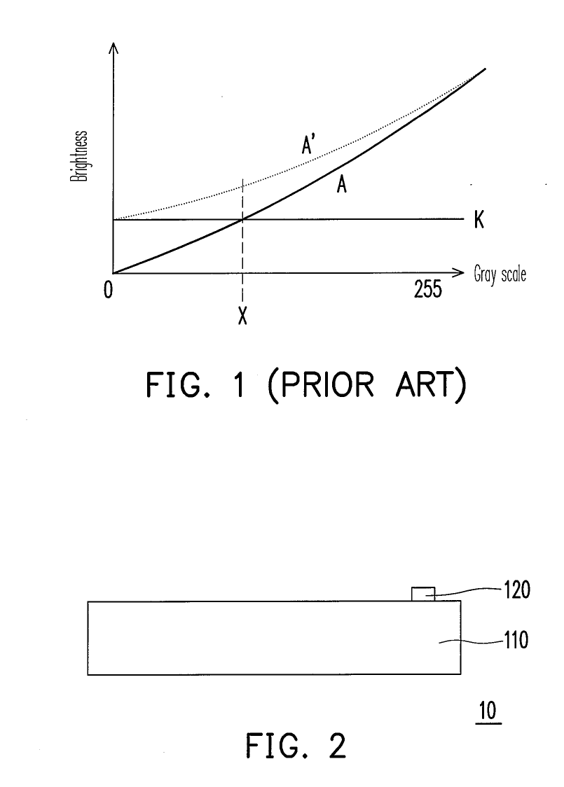

Referring to FIG. 2, a display apparatus 10 according to an embodiment of the present invention includes a displaying unit 110 and an ambient brightness sensor 120. The ambient brightness sensor 120 is disposed on and electrically connected with the displaying unit 110. Wherein, the displaying unit 110 is used for providing an image according to a gamma curve. A plurality of gamma curves is stored in the displaying unit 110 and each gamma curve is corresponding to a gamma constant. The ambient brightness sensor 120 is used for detecting the ambient brightness and selecting a corresponding gamma curve according to the result of the detection. The displaying unit 110 provides an image based on the selected gamma curve. For example, the above displaying unit 110 is a projecting system, a liquid crystal display, a Plasma Display Panel (PDP), a Cathode Ray Tube (CRT), an Organic Electro-Luminescent Display panel (OELD panel), a Lighting Emitting Diode Display panel (LED panel) or a Field Emission Display panel (FED panel). Besides, the ambient brightness sensor 120 is, for example, a Photo Diode (PD).

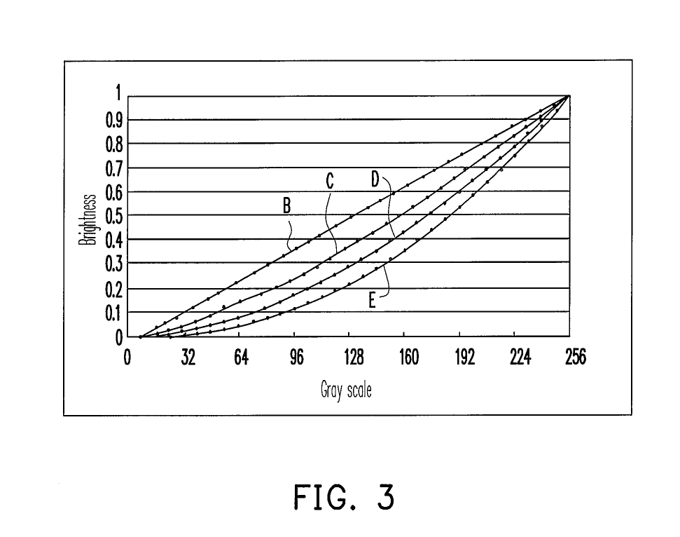

Referring to FIG. 3, the displaying unit 110 stores, for example, four gamma curves B, C, D and E corresponding to gamma constants g of 1, 1.4, 1.6 and 2.2 respectively. The gamma curves B, C, D and E are used for the basis of the relation between brightness and gray scale value when the displaying unit 110 outputs images. Wherein, the gamma curve E with a gamma constant 2.2 is most suitable for human eyes and is suitable for common ambient brightness. When the display apparatus 10 starts up, the ambient brightness sensor 120 starts detecting the ambient brightness around the display apparatus 10 and obtaining the specific ambient brightness. Then, one gamma curve is selected from the four gamma curves according to the ambient brightness, and the displaying unit 110 provides an image based on the selected gamma curve.

For example, when the ambient brightness detected by the ambient brightness sensor 120 is 0.2, if the displaying unit 110 provides an image with gamma curve E, only the brightness corresponding to the gray scale value 120 to 256 will exceed the ambient brightness and the part with gray scale value 0 to 120 will not be normally displayed due to insufficient brightness. Here, the displaying unit 110 adopts the gamma curve B to provide an image according to the detected result from the ambient brightness sensor 120. Thus, the gray scale value, which is not displayed normally, reduces to 0 to 50. Thereby the displaying unit 110 provides an image suitable for users in the brighter surroundings. Of course, a gamma curve corresponding to different ambient brightness is predetermined beforehand.

As described above, the display apparatus 10 is capable of effectively selecting the suitable gamma curve and providing the preferable image according to the ambient brightness changes by using the ambient brightness sensor 120.

In summary, the display apparatus of the present invention detects the brightness of the surroundings because of the use of the ambient brightness sensor. Furthermore, the display apparatus is capable of providing an image suitable for the current ambient brightness by properly selecting a corresponding gamma curve according to the feedback of the detected result. Accordingly, the display apparatus of the present invention is able to provide the preferable image by properly selecting a gamma curve in time.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display apparatus, comprising:
a displaying unit, wherein a plurality of gamma curves is stored in the displaying unit and an image is provided by the displaying unit based on one of the plurality of gamma curves; and
an ambient brightness sensor, disposed on and electrically connected with the displaying unit to be used for sensing the ambient brightness and selecting the gamma curve according to a detected result.

2. The display apparatus as claimed in claim 1, wherein each gamma curve corresponds to a gamma constant.

3. The display apparatus as claimed in claim 1, wherein the displaying unit comprises a projecting system, a liquid crystal display, a Plasma Display Panel (PDP), a Cathode Ray Tube (CRT), an Organic Electro-Luminescent Display panel (OELD panel), a Lighting Emitting Diode Display panel (LED panel) or a Field Emission Display panel (FED panel).

4. The display apparatus as claimed in claim 1, wherein the ambient brightness sensor comprises a Photo Diode (PD).
